(19) United States
(12) Patent Application Publication
(10) Pub. No.: US 2009/0212576 A1
(43) Pub. Date: Aug. 27, 2009

(54) Dual Backset latch Assembly for Auxiliary Lock

(76) Inventor: Cheng-Hsuan Chang, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/035,545

(22) Filed: Feb. 22, 2008

(51) Int. Cl. E05C 1/08

(52) U.S. Cl. 292/1.5

(57) ABSTRACT

A dual backset latch assembly for an auxiliary lock includes a housing, a casing mounted to a rear end of the housing, and a latch slideably received in the housing. A pull plate is fixed to the latch to move therewith and includes first and second engaging portions. A drive member includes a pivotal portion pivotably received in aligned pivotal holes of two side plates received in the casing such that an end of the drive member is moveable between an engaging position engaged with one of the first and second engaging portions and a disengaged position disengaged from the first and second engaging portions. When the end of the drive member is in the disengaged position, the pivotal portion is moveable between first and second positions spaced in the longitudinal direction of the housing corresponding two different backset lengths.

### BACKGROUND OF THE INVENTION

The present invention relates to a dual backset latch assembly and, more particularly, to a latch assembly for an auxiliary lock with an adjustable backset.

There are two standard backset lengths (60 mm and 70 mm) for door locks including auxiliary locks. Dual backset latch assemblies for auxiliary locks have been proposed to allow adjustment of the backset length. In a conventional dual backset latch assembly for auxiliary locks, two assembling plates are mounted outside a casing that is attached to a rear end of a housing in which a latch is slideably received. A pull plate is mounted to a rear end of the latch. A driving wheel is rotatably received in the casing. An adjusting plate is mounted on top of the pull plate and engaged in one of two positioning grooves in the pull plate. The driving wheel can be turned in a direction to drive the adjusting plate and the pull plate to extend or retract the latch. On the other hand, the driving wheel can be turned in a reverse direction to disengage the adjusting plate from one of the positioning grooves. Then, the adjusting plate can be moved to another position engaged in the other positioning groove to adjust the backset length. However, such a dual backset latch assembly is complicated and expensive.

A need exists for a dual backset latch assembly for an auxiliary lock that allows adjustment of the backset length while having a simpler structure.

### BRIEF SUMMARY OF THE INVENTION

The present invention solves this need and other problems in the field of auxiliary locks by providing, in a preferred form, a dual backset latch assembly including a housing and a latch slideably received in the housing and movable in a longitudinal direction of the housing between an extended, latching position and a retracted, unlatching position. A pull plate is fixed to the latch to move therewith and includes first and second engaging portions spaced in the longitudinal direction of the housing. A casing is mounted to a rear end of the housing and includes a guide slot having first and second positioning grooves spaced in the longitudinal direction of the housing. The casing further includes first and second holes on opposite sides of the guide slot and spaced in the longitudinal direction of the housing. First and second side plates are coupled with each other and received in the casing. The first and second side plates are spaced in a direction transverse to the longitudinal direction of the housing and include aligned pivotal holes. The first and second side plates further include aligned first through-holes and aligned second through-holes spaced from the first through-holes in the longitudinal direction of the housing. A drive member includes a pivotal portion pivotably received in the pivotal holes and an end moveable between an engaging position engaged with one of the first and second engaging portions of the pull plate and a disengaged position disengaged from the first and second engaging portions. The pivotal portion is adapted to be extended through by a spindle of an auxiliary lock to turn therewith.

When the end of the drive member is in the engaged position, the first and second side plates and the drive member are fixed relative to the casing, and the pivotal portion is drivable by the spindle to move the latch between the extended, latching position and the retracted, unlatching position via the pull plate.

When the end of the drive member is in the disengaged position, the first and second side plates and the drive member are slideable relative to the casing such that the pivotal portion is moveable in the guide slot between first and second positions spaced in the longitudinal direction of the housing corresponding two different backset lengths.

When the pivotal portion is in the first position, the first through-holes of the first and second side plates are aligned with the first hole of the casing, and the second through-holes of the first and second side plates are aligned with the first positioning hole of the casing.

When the pivotal portion is in the second position, the first through-holes of the first and second side plates are aligned with the second positioning hole of the casing, and the second through-holes of the first and second side plates are aligned with the second hole of the casing.

In the most preferred form, the second side plate includes first and second stops spaced in the longitudinal direction of the housing. The drive member is stopped by the first stop when the latch is in the extended, latching position. The drive member is stopped by the second stop when the end of the drive member is in the disengaged position. The pivotal portion further includes a protrusion extending from an outer periphery thereof. An axle is extended transversely through the first and second side plates. A torsion spring is mounted around the axle and includes a first tang attached to the protrusion and a second tang attached to one of the first and second side plates for retaining the drive member in place. The first and second side plates include aligned limiting slots. A pin is fixed to the casing and slideably received in the limiting slots to allow stable movement of the first and second side plates and the pivotable portion between the first and second positions.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows an exploded, perspective view of an auxiliary lock utilizing a dual backset latch assembly according to the preferred teachings of the present invention and a portion of a door to which the auxiliary lock is mounted.

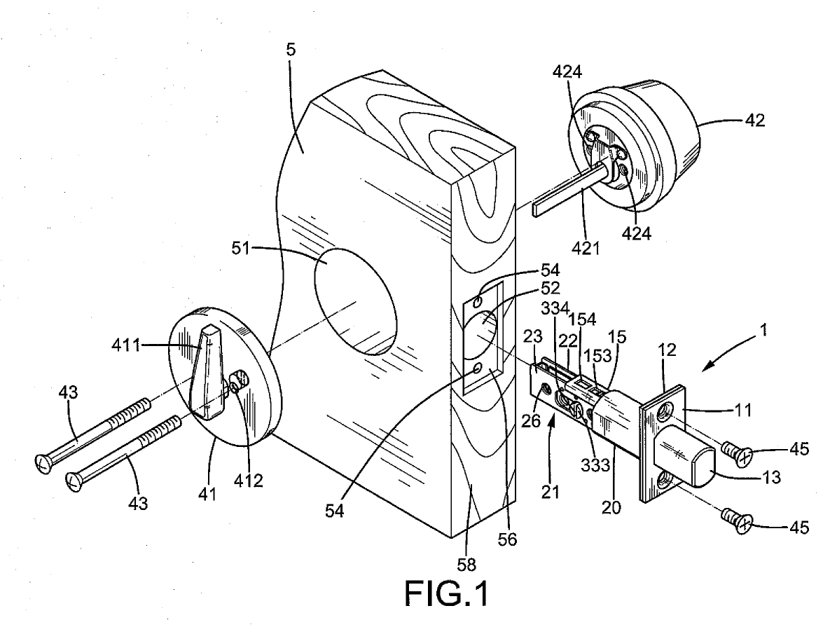

FIG. 2 shows a partial, cross-sectional view of the auxiliary lock of FIG. 1.

FIG. 3 shows a cross-sectional view of the auxiliary lock of FIG. 1 according to section line 3-3 of FIG. 2 with the latch assembly having a shorter backset length.

FIG. 4 shows an exploded, perspective view of the latch assembly of FIG. 1.

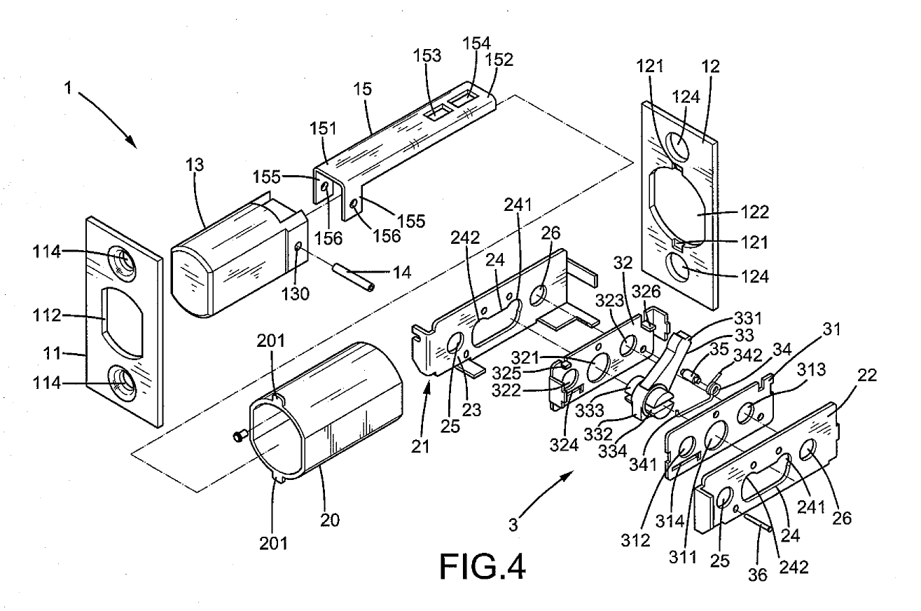

FIG. 5 shows a cross-sectional view of the latch assembly of FIG. 4, illustrating adjustment of the backset length of the latch assembly.

FIG. 6 shows a cross-sectional view of the auxiliary lock of FIG. 1 according to section line 3-3 of FIG. 2 with the latch assembly having a longer backset length.

FIG. 7 shows a cross-sectional view of the auxiliary lock of FIG. 1 according to section line 3-3 of FIG. 2 with the latch assembly having a shorter backset length and with a latch of the latch assembly in an extended state.

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “end”, “portion”, “longitudinal”, “clockwise”, “counterclockwise”, “length”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

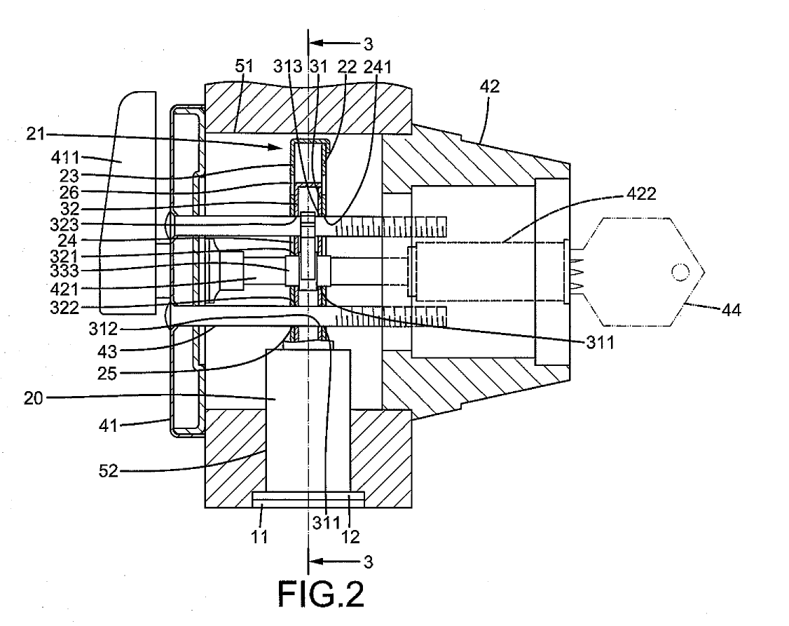

A dual backset latch assembly according to the preferred teachings of the present invention is shown in the drawings and generally designated 1. The dual backset latch assembly 1 can be utilized as a part of an auxiliary lock that is generally mounted to a door as an auxiliary locking device. It can be appreciated that the auxiliary lock can be utilized on a door alone. According to the preferred form shown, the auxiliary lock includes an inner assembly 41 and an outer assembly 42 mounted to a bore 51 of a door 5 and the dual backset latch assembly 1 mounted in a compartment 52 in an edge 58 of the door 5 and in communication with the bore 51. The inner and outer assemblies 41 and 42 and the latch assembly 1 are mounted to the door 5 by two fasteners 43. Specifically, the fasteners 43 are extended through two holes 412 of the inner assembly 41 into two screw holes 424 of the outer assembly 42. The inner assembly 41 is located on an outer side of the door 5 and includes a lock core 422 and a spindle 421 having an end operably connected to the lock core 422. The other end of the spindle 421 is extended through the bore 51 and attached to a thumbturn 411 of the inner assembly 41 located on an inner side of the door 5. When a key 44 (FIG. 2) is inserted into the lock core 422 and turned or the thumbturn 411 is turned, the spindle 421 is turned to extend or retract a latch 13 of the latch assembly 1 for latching/unlatching purposes. Other forms of the inner and outer assemblies 41 and 42 would be within the skill of the art.

According to the preferred form shown, the latch assembly 1 includes a housing 20 slideably receiving the latch 13 and a casing 21 mounted to a rear end of the housing 20. The housing 20 is fixed in the compartment 52 of the door 5 via a faceplate. The housing 20 includes two tabs 201 on a front end thereof. In the preferred form shown, the faceplate includes front and rear plates 11 and 12 mounted in a recessed portion 56 of the edge 58 of the door 5. The front and rear plates 11 and 12 include aligned slots 112 and 122 slideably receiving the latch 13. The front and rear plates 11 and 12 further includes aligned holes 114, 124 through which screws 45 are extended into two mounting holes 54 in a bottom wall of the recessed portion 56. The rear plate 12 includes two spaced notches 121 receiving the tabs 201 of the housing 20. Thus, the housing 20 is fixed in the compartment 52 of the door 5, and the tabs 201 are securely sandwiched between the front and rear plates 11 and 12. Other forms of the faceplate and other arrangements for coupling the housing 20 with the faceplate would be within the skill of the art. Also, other arrangements for fixing the faceplate and the housing 20 in the compartment 52 of the door 5 would be within the skill of the art.

According to the preferred form shown, a pull plate 15 is mounted to a rear end of the latch 13. In the most preferred form shown, the pull plate 15 includes a front end 151 having two spaced lugs 155 with aligned holes 156. A pin 14 is extended through the holes 156 of the lugs 155 and a transverse through-hole 130 in a rear end of the latch 13. The pull plate 15 further includes a rear end 152 having first and second engaging portions 153 and 154 shown in the form of two slots spaced in the longitudinal direction of the housing 20.

According to the preferred form shown, the casing 21 includes first and second side boards 22 and 23 coupled with each other and spaced in a direction transverse to the longitudinal direction of the housing 20 and having aligned guide slots 24. Each guide slot 24 includes first and second positioning grooves 241 and 242 spaced in the longitudinal direction of the housing 20. The first and second side boards 22 and 23 further includes aligned first holes 25 and aligned second holes 26 spaced in the longitudinal direction of the housing 20. The first and second holes 25 and 26 on the first side board 22 are on opposite sides of the guide slot 24 of the first side board 22, and the first and second holes 25 and 26 of the second side board 23 are on opposite sides of the guide slot 24 of the second side board 22.

According to the preferred form shown, the dual backset latch assembly 1 further includes an adjusting mechanism 3 including first and second side plates 31 and 32 coupled with each other and received in the casing 21. The first and second side plates 31 and 32 are spaced in a direction transverse to the longitudinal direction of the housing 20 and include aligned pivotal holes 311 and 321. The first and second side plates 31 and 32 further includes aligned first through-holes 312 and 322 and aligned second through-holes 313 and 323 spaced from the first through-holes 312 and 322 in the longitudinal direction of the housing 20 and on opposite sides of the aligned pivotal holes 311 and 321. The first and second side plates 31 and 32 further includes aligned limiting slots 314 each below one of the first through-holes 312 and 322. The second side plate 32 includes first and second stops 325 and 326 spaced in the longitudinal direction of the housing 20.

According to the preferred form shown, the adjusting mechanism 3 further includes a drive member 33 received between the first and second side plates 31 and 32. The drive member 33 includes a pivotal portion 333 pivotably received in the pivotal holes 311 and 321. The drive member 33 further includes an end 331 releasably engaged with one of the first and second engaging portions 153 and 154 of the pull plate 15. Specifically, the end 331 of the drive member 33 is moveable between an engaging position engaged with one of the first and second engaging portions 153 and 154 and a disengaged position disengaged from the first and second engaging portions 153 and 154. A protrusion 332 is formed on an outer periphery of the pivotal portion 333. The pivotal portion 333 includes a hole 334 through which the spindle 421 extends to allow joint pivotal movement of the spindle 421 and the drive member 33. An axle 35 is extended transversely through the first and second side plates 31 and 32. A torsion spring 34 is mounted around the axle 35 and includes a first tang 341 attached to the protrusion 332 and a second tang 342 attached to one of the first and second side plates 31 and 32. Thus, the drive member 33 is retained in plate by the torsion spring 34. A pin 36 is fixedly extended through the first and second side boards 22 and 23 and slideably extended through the limiting slots 314 and 324 of the first and second side plates 31 and 32.

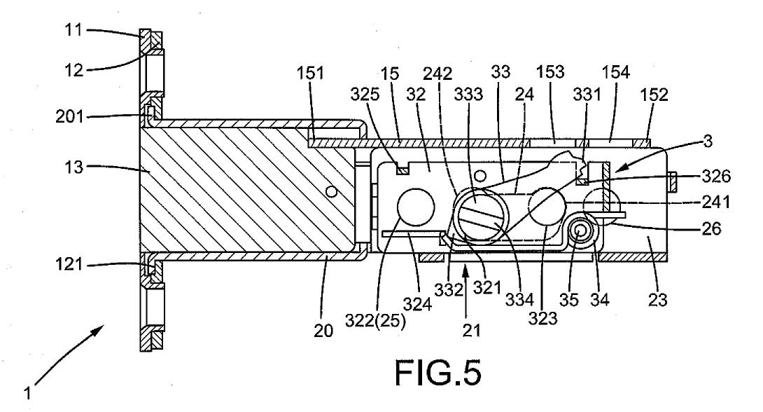

When the end 331 of the drive member 33 is in the disengaged position, the first and second side plates 31 and 32 and the drive member 33 are slideable relative to the casing 21 such that the pivotal portion 333 is moveable in the guide slot 24 between first and second positions spaced in the longitudinal direction of the housing 20 corresponding two different backset lengths. Specifically, before the fasteners 43 are mounted, the drive member 33 can be pivoted clockwise to the disengaged position (FIG. 5) and stopped by the second stop 326. Since the end 331 of the drive member 33 is disengaged from the first and second engaging portions 153 and 154 of the pull plate 15, the first and second side plates 31 and 32 and the drive member 33 are together moveable in the longitudinal direction of the housing 20 between the first and second positions of the pivotal portion 333. After the pivotal portion 333 reaches one of the first and second positions, the drive member 33 can be pivoted counterclockwise to engage with one of the first and second engaging positions 153 and 154 of the pull plate 15. It can be appreciated that the limiting slots 314 of the first and second side plates 31 and 32 slideably receiving the pin 36 allows stable movement of the first and second side plates 31 and 32 and the pivotal portion 333 between the first and second positions.

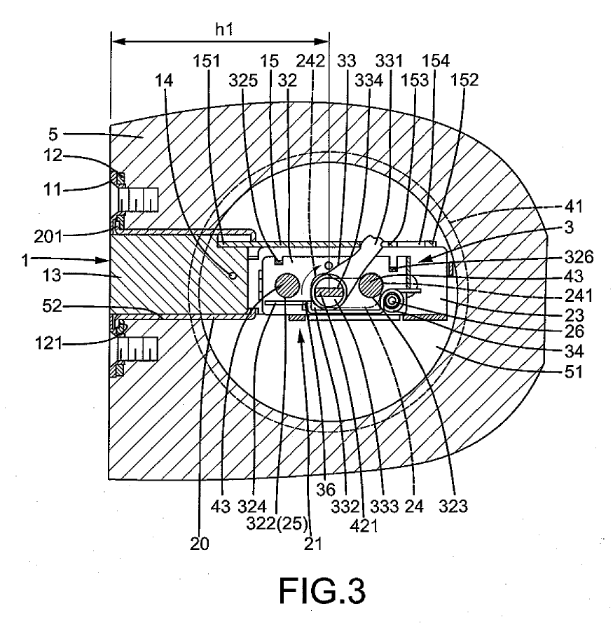

When the pivotal portion 333 is in the first position (FIGS. 2 and 3), one of the fasteners 43 is extended through the first holes 25 of the casing 21 and the first through-holes 312 and 322 of the first and second side plates 31 and 32 that are aligned with the first holes 25, and the other fastener 43 is extended through the first positioning holes 241 of the casing 21 and the second through-holes 313 and 323 of the first and second side plates 31 and 32 that are aligned with the first positioning holes 241. In this case, the latch assembly 1 has a shorter backset length h1 of 60 mm.

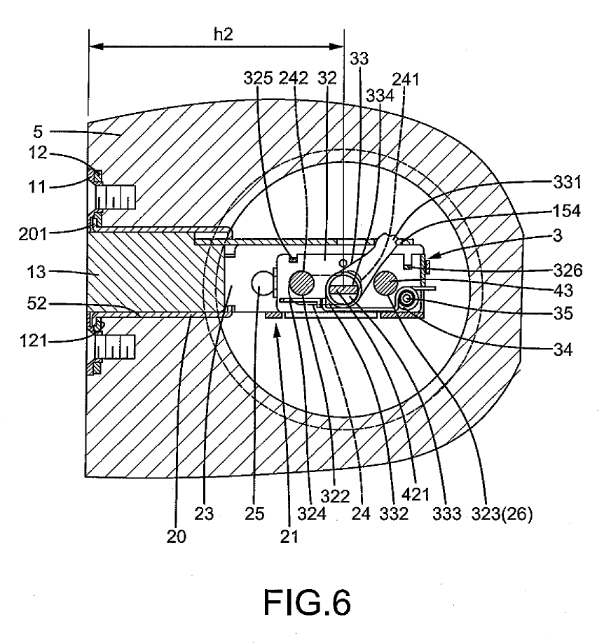

When the pivotal portion 333 is in the second position (FIG. 6), one of the fasteners 43 is extended through the second positioning holes 242 of the casing 21 and the first through-hole 312 and 322 of the first and second side plates 31 and 32 that are aligned with the second positioning holes 242, and the other fastener 43 is extended through the second holes 26 of the casing 21 and the second through-holes 313 and 323 of the first and second side plates 31 and 32 that are aligned with the second holes 26. In this case, the latch assembly 1 has a longer backset length h2 of 70 mm.

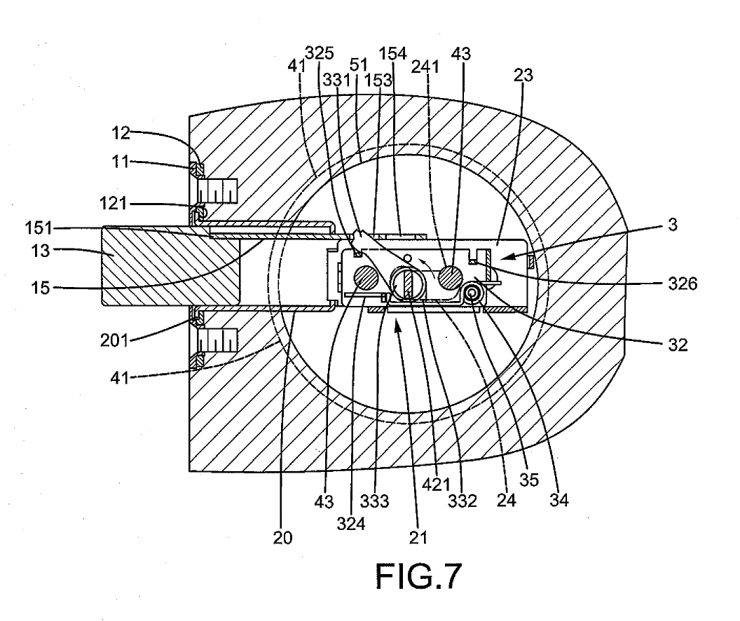

When the end 331 of the drive member 33 is in the engaged position engaged with one of the first and second engaging portions 153 and 154 of the pull plate 15, the first and second side plates 31 and 32 and the drive member 33 are fixed relative to the casing 21, and the pivotal portion 333 is drivable by the spindle 421 to move the latch 13 between the extended, latching position (FIG. 7) and the retracted, unlatching position (FIG. 3, 6) via the pull plate 15. It can be appreciated that the drive member 33 is stopped by the first stop 325 when the latch 13 is in the extended, latching position.

It can be appreciated that after mounting the fasteners 43, pivotal movement of the drive member 33 in an attempt to disengage the end 331 of the drive member 33 from the pull plate 15 is not allowed, for the pivotal movement of the drive member 33 will be hindered by one of the fasteners 43.

Now that the basic teachings of the present invention have been explained, many extensions and variations will be obvious to one having ordinary skill in the art. For example, the guide slot 24 and the first and second holes 25 and 26 in one of the side boards 22 and 23 of the casing 21 can be omitted. The pin 36 and the limiting slots 314 and 324 of the first and second side plates 31 and 32 can be omitted.

The dual backset latch assembly 1 according to the preferred teachings of the present invention is simple in structure and, thus, can be manufactured at low costs while allowing reliable adjustment of two different backset lengths.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A dual backset latch assembly for an auxiliary lock comprising:
a housing (20) having a rear end;
a latch (13) slideably received in the housing (20) and movable in a longitudinal direction of the housing (20) between an extended, latching position and a retracted, unlatching position;
a pull plate (15) fixed to the latch (13) to move therewith and including first and second engaging portions (153, 154) spaced in the longitudinal direction of the housing (20);
a casing (21) mounted to the rear end of the housing (20) and including a guide slot (24) having first and second positioning grooves (241, 242) spaced in the longitudinal direction of the housing (20), with the casing (21) further including first and second holes (25, 26) on opposite sides of the guide slot (24) and spaced in the longitudinal direction of the housing (20);
first and second side plates (31, 32) coupled with each other and received in the casing (21), with the first and second side plates (31, 32) being spaced in a direction transverse to the longitudinal direction of the housing (20) and including aligned pivotal holes (311, 321), with the first and second side plates (31, 32) further including aligned first through-holes (312, 322) and aligned second through-holes (313, 323) spaced from the first through-holes (312, 322) in the longitudinal direction of the housing (20);
a drive member (33) including a pivotal portion (333) pivotably received in the pivotal holes (311, 321) and an end (331) moveable between an engaging position engaged with one of the first and second engaging portions (153, 154) of the pull plate (15) and a disengaged position disengaged from the first and second engaging portions (153, 154), with the pivotal portion (333) being adapted to be extended through by a spindle (421) of an auxiliary lock to turn therewith,
wherein when the end (331) of the drive member (33) is in the engaged position, the first and second side plates (31, 32) and the drive member (33) are fixed relative to the casing (21), and the pivotal portion (333) is drivable by the spindle (421) to move the latch (13) between the extended, latching position and the retracted, unlatching position via the pull plate (15),
wherein when the end (331) of the drive member (33) is in the disengaged position, the first and second side plates (31, 32) and the drive member (33) are slideable relative to the casing (21) such that the pivotal portion (333) is moveable in the guide slot (24) between first and second positions spaced in the longitudinal direction of the housing (20) corresponding two different backset lengths,
wherein when the pivotal portion (333) is in the first position, the first through-holes (312, 322) of the first and second side plates (31, 32) are aligned with the first hole (25) of the casing (21), and the second through-holes (313, 323) of the first and second side plates (31, 32) are aligned with the first positioning hole (241) of the casing (21),
wherein when the pivotal portion (333) is in the second position, the first through-holes (312, 322) of the first and second side plates (31, 32) are aligned with the second positioning hole (242) of the casing (21), and the second through-holes (313, 323) of the first and second side plates (31, 32) are aligned with the second hole (26) of the casing (21).

2. The dual backset latch assembly for an auxiliary lock as claimed in claim 1, with the second side plate (32) including first and second stops (325, 326) spaced in the longitudinal direction of the housing (20), with the drive member (33) being stopped by the first stop (325) when the latch (13) is in the extended, latching position, and with the drive member (33) being stopped by the second stop (326) when the end (331) of the drive member (33) is in the disengaged position.

3. The dual backset latch assembly for an auxiliary lock as claimed in claim 1, with the pivotal portion (331) further including a protrusion (332) extending from an outer periphery thereof, with the dual backset latch assembly further comprising, in combination: an axle (35) extending transversely through the first and second side plates (31, 32); and a torsion spring (34) mounted around the axle (35) and including a first tang (341) attached to the protrusion (332) and a second tang (342) attached to one of the first and second side plates (31, 32) for retaining the drive member (33) in place.

4. The dual backset latch assembly for an auxiliary lock as claimed in claim 1, with the first and second side plates (31, 32) including aligned limiting slots (314, 324), with the dual backset latch assembly further comprising, in combination: a pin (36) fixed to the casing (21) and slideably received in the limiting slots (314, 324) to allow stable movement of the first and second side plates (31, 32) and the pivotable portion (333) between the first and second positions.
